(19) United States
(12) Patent Application Publication
(10) Pub. No.: US 2007/0037918 A1
(43) Pub. Date: Feb. 15, 2007

(54) Fluororesin compound

(76) Inventor: Goshiki Keigo, Saitama (JP)

Correspondence Address: COLLEN IP, THE HOLYOKE MANHATTAN BUILDING, 80 SOUTH HIGHLAND AVENUE, OSSINING, NY, 10562, US

(21) Appl. No.: 10/577,808

(22) PCT Filed: Oct. 28, 2004
(86) PCT No.: PCT/JP04/16362

§ 371 Date: Apr. 28, 2006

(30) Foreign Application Priority Data
Oct. 31, 2003 (JP) 2003-372251
Nov. 13, 2003 (JP) 2003-384006

(51) Int. Cl. C08K 3/04; D06M 15/277

(52) U.S. Cl. 524/495; 523/200; 524/544; 524/462

(57) ABSTRACT

In a fluororesin composition, a fluororesin composition comprising a fluororesin in which terminal groups are stabilized, and carbon nanotubes, and in a fluororesin composition, a fluororesin composition comprising a blend of a fluororesin and carbon nanotubes surface treated with a fluorine-based surfactant, are constituted, whereby a fluororesin composition excellent in electrical properties such as conductivity and static charging characteristics can be provided.

### TECHNICAL FIELD

The present invention relates to a fluororesin composition, and particularly, to a fluororesin composition that can be used in, for example, a conductive material having excellent surface resistance.

### BACKGROUND ART

A resin composition comprising a synthetic resin material having contained therein a conductive filler is used in various applications including electronic materials, as a conductive material having characteristics.

It is proposed in, for example, JP-A-2003-192914 to use carbon nanotubes as a conductive filler comprising the conventional conductive carbon black, as a filler.

Where the carbon nanotubes are added to a synthetic resin as a conductive filler, it is known to show the same degree of conductivity with the addition amount of from ⅓ to ¼ as compared with the case of adding PAN-based carbon fibers. This is said to be due to that the carbon nanotubes have high conductivity and high aspect ratio, as compared with the conventional carbonaceous conductive filler, so that a network structure is liable to be formed in the synthetic resin blended, and further that the carbon nanotubes are fine and have small bulk density, so that the number of nanotubes per unit weight is large.

Further, where a conductive material containing a carbonaceous conductive filler is used as various electronic materials, electronic devices, shielding materials of electric cables, and the like, there was the possibility that serious problems such as short circuit of electrical circuit would be generated, when the conductive filler falls off in the reason such as friction induce.

However, the carbon nanotubes are a fine substance having a small size as compared with the conventional conductive carbon material, and had the characteristics that “lifting” originated from the resin composition does not almost occur, surface state is excellent, and because of having large strength and a modulus of elasticity, falling off by breakage is less.

The carbon nanotubes are constituted of only carbon atoms, do not almost contain impurities, as being different from carbon black and the like, do not change even if exposed to high temperature when molding or using, and do not have the possibility to decompose a synthetic resin blended or to generate gas from a molding. Thus, the carbon nanotubes are expected as a material for electronic parts.

It is also proposed to blend the carbon nanotubes as a filler with a fluororesin. Where the carbon nanotubes are blended with the fluororesin as a filler, it is possible to provide a fluororesin composition having both excellent properties of the carbon nanotubes and chemical stability possessed by the fluororesin.

### DISCLOSURE OF THE INVENTION

The present invention relates to a fluororesin composition, and has an object to provide a fluororesin composition containing a fluororesin and carbon nanotubes as a conductive filler, the composition having good conductive properties and static charging properties.

The subject of the invention can be solved by a fluororesin composition comprising a fluororesin in which terminal groups are stabilized, and carbon nanotubes.

The invention further provides the fluororesin composition, wherein the fluororesin in which terminal groups are stabilized is a perfluoroalkoxyalkane polymer or a perfluoroethylene propylene copolymer.

The invention further provides the fluororesin composition, wherein the carbon nanotubes are at least one kind selected from single wall carbon nanotubes, multiwalled carbon nanotubes, and gas phase growth carbon fibers.

Further, the subject of the invention can be solved by a fluororesin composition comprising a blend of a fluororesin and carbon nanotubes which are surface treated with a fluorine-based surfactant.

In this embodiment, the fluororesin composition is that the fluorine-based surfactant is at least one kind selected from the group consisting of fluoroalkylsulfonic acid, fluoroalkylcarboxylic acid, and their salts.

Further, in the fluororesin composition comprising a blend of a fluororesin and carbon nanotubes which are surface treated with a fluorine-based surfactant, the fluororesin is that terminal groups are stabilized, and the fluororesin in which terminal groups are stabilized is preferably selected from a perfluoroalkoxyalkane polymer or a perfluoroethylene propylene copolymer.

In the fluororesin composition comprising a blend of a fluororesin and carbon nanotubes which are surface treated with a fluorine-based surfactant, because the carbon nanotubes are previously surface treated with a fluorine-based surfactant, and then mixed with the fluororesin, affinity between the carbon nanotubes and the fluororesin increases, and falling off of the carbon nanotubes from the fluororesin becomes less, and further a fluororesin composition having large conductivity can be obtained by improvement of the mutual affinity of the fluororesins.

The fluororesin composition in one embodiment of the invention uses a fluororesin in which terminal groups are stabilized as a fluororesin, and further blends carbon nanotubes as a conductive filler. As a result, the composition has large conductivity by a small blending proportion, and is useful in low noise, electromagnetic wave-shielding materials, and the like. Further, a composition in which static charging characteristics are good, the carbon nanotubes used as a filler do not fall off, and static charging is small, is obtained. Therefore, a composition very useful as various electronic part materials and the like, requiring high reliability is obtained.

The fluororesin composition in other embodiment of the invention is that the carbon nanotubes are treated with a fluorine-based surfactant, and then blended as a conductive filler, and as a result, such a composition has large conductivity with smaller blending amount, and is useful as low noise, electromagnetic wave-shielding materials, and the like. Further, a composition wherein the static charging characteristics are good, the carbon nanotubes used as a filler do not fall off, and static charging is small, is obtained. Therefore, a composition very useful as various electronic part materials and the like, requiring high reliability is obtained.

Further, because the required conductive characteristics are obtained by blending a small amount of carbon nanotubes, decrease in process ability due to filler blending can be minimized without deterioration of surface properties or mechanical properties that the fluororesin inherently possesses.

### BEST MODE FOR CARRYING OUT THE INVENTION

The embodiment according to the invention is described below.

It has been found in one embodiment of the invention that where terminal groups in a fluororesin are unstable in a fluororesin composition using carbon nanotubes as a conductive filler, conductivity of the carbon nanotubes greatly lowers under high temperature higher than the melting point at which the fluororesin is processed, whereas where terminal groups in the fluororesin are stabilized, decrease phenomenon of conductivity, and the like can be suppressed. This finding has achieved the invention.

The fluororesin is a resin having excellent chemical resistance and the like as compared with other synthetic resins, and is widely used in fields requiring chemical resistance, fields requiring heat resistance, or fields requiring no contamination of a liquid by substances eluted from plastics.

In particular, a fluoropolymer produced by polymerization of fluoromonomers can be molded into various shapes, and therefore is suitable for the production of a fluororesin composition having a conductive filler kneaded therewith.

In the case of polymerization of the fluoromonomers, an initiator, a chain transfer agent, and the like are blended. Therefore, it has not been avoided that chemically unstable terminal groups, such as amide group, carbinol group, carboxyl group, and the like are formed in a polymer formed, due to action of those chemicals, or a side-reaction.

Such unstable terminal groups have the possibility to react, and this may give rise the problem depending on the purpose of use of the fluororesin. In, for example, the semiconductor production step requiring high stability, such unstable terminal groups are fluorinated with a fluorinating agent such as fluorine gas, and a fluororesin in which the terminal groups are stabilized is used.

It has been found in another embodiment of the invention that where conductivity is imparted by blending carbon nanotubes with a fluororesin in which terminal groups are stabilized, such a composition exhibits excellent properties in the points of electric conductivity and static charging characteristics with small blending amount, without deterioration of the physical properties.

The fluororesin in which terminal groups are stabilized, that can be used in the production of the fluororesin composition according to another embodiment of the invention, is a resin in which the terminal groups have been subjected to fluorination treatment using a fluorinating agent after polymerization. Specifically, there can be mentioned at least one kind selected from a tetrafluoroethylene-hexafluoropropylene copolymer (FEP), a tetrafluoroethylene-fluoroalkylvinyl ether copolymer (PFA), a tetrafluoroethylene-ethylene copolymer (ETFE), a tetrafluoroethylene-hexafluoropropylene-vinylidene fluoride terpolymer (THV), a polytetrafluoroethylene (PTFE), a polyvinylidene fluoride (PVdF), and a polychlorotrifluoroethylene (PCTFE).

Of those, overall fluorinated polymers are preferable, and a tetrafluoroethylene-hexafluoropropylene copolymer (FEP) and a tetrafluoroethylene-fluoroalkylvinyl ether copolymer (PFA) are more preferable.

Further, in one embodiment of the invention, a fluororesin in which terminal groups are not stabilized may be blended in combination with the fluororesin in which terminal groups are stabilized. In this case, it is preferable that 1/3 or more of the total mass of the fluororesins used is the fluororesin in which terminal groups are stabilized, and it is more preferably that ½ or more of the total mass of the fluororesins used is the fluororesin in which terminal groups are stabilized.

The carbon nanotubes that can be used in the fluororesin composition in one embodiment of the invention can mention carbon nanoporous bodies having conductivity, such as single wall carbon nanotubes (SWCNT), multiwalled carbon nanotubes (MWCNT), vapor phase growth carbon fibers (VGCF), carbon nanohorns, and the like.

Further, the carbon nanotubes have a diameter of preferably from 1 nm to 300 nm, and an aspect ratio of preferably 5 or more.

In one embodiment of the invention, the carbon nanotubes are preferably 0.1 mass % or more, and more preferably 1 mass % or more, based on the mass of the whole composition. However, the blending ratio can adjust the blending amount according to conductive characteristics of the fluororesin composition.

The carbon nanotubes may be used as a masterbatch in which a resin has previously been mixed and kneaded, from the point of improving dispersibility to the fluororesin. It is preferable that the resin used for the formation of the masterbatch uses the same fluororesin as in the fluororesin composition finally produced.

After mixing the fluororesin and the carbon nanotubes in a predetermined proportion, the fluororesin composition in one embodiment of the invention can be molded into the desired shape by an extrusion molding method, a roll molding method, an injection molding method or the like.

The invention is described below by referring to the following Examples and Comparative Examples.

### EXAMPLE

Each of fluororesin pellets and carbon nanotubes was supplied to a hopper of a twin-screw extruder (KZW20-25G, a product of Technovel Corp.) from two feeders so as to become the weight proportion shown in Table 1. The twin-screw extruder was set such that a cylinder temperature is 330° C., and a die temperature is 340° C., and the fluororesin and the carbon nanotubes were melt-kneaded and extruded into a strand form at the number of revolutions of a screws of 30 rpm. After cooling in a water bath, pellets having a diameter of 1.5 mm and a length of 3 mm were produced with a pelletizer.

Samples 5 to 7 were that pellets of fluororesins PFA450HPJ and 350J were previously mixed uniformly, and supplied from the feeder. Further, Comparison 3 was that after drying FEP120J which is a dispersion, the surfactant was washed out with acetone, a strand was extruded with a single-screw extruder, and pellets were formed with a pelletizer and were used.

Measurement of Conductivity

Conductivity was determined by kneading with a twin-screw extruder, molding 10 g of the pellets obtained into a sheet form having a thickness of 0.2 mm with a hot press at 350° C., and measuring a surface resistance using a high resistivity meter (HIRESTA-IP, a product of Mitsubishi Chemical Corp.) and a low resistivity meter (LORESTA-AP, a product of Mitsubishi Chemical Corp.). The evaluation results are shown in Table 1.

In Table 1, comparison means a comparative example.

Measurement of Static Charging Properties

100 g of sample pellets was charge eliminated using a static eraser (SF-1000, a product of As One Corporation), and placed in a polyethylene bag. A mouth of the bag is closed while inflating the bag, and the bag was vigorously shaken up and down 10 times. It was judged as to whether or not the pellets in the bag adhered to a wall of the bag by static electricity. Where the pellets did not adhered, it was judged as “good”, and where the pellets adhered, it was judged as “poor”.

In Table 1, PFA450HPJ and PFA440HPJ each show a tetrafluoroethylene-fluoroalkylvinyl ether copolymer (PFA) in which terminal groups are stabilized, a product of Mitsui Du Pont Fluorochemical Co., and FEP100J shows a tetrafluoroethylene-hexafluoropropylene copolymer (FEP) in which terminal groups are stabilized, a product of Mitsui Du Pont Fluorochemical Co.

Further, PFA350J and PFA340J each show a tetrafluoroethylene-fluoroalkylvinyl ether copolymer (PFA) in which terminal groups are not stabilized, a product of Mitsui Du Pont Fluorochemical Co., and FEP120J shows a tetrafluoroethylene-hexafluoropropylene copolymer (FEP) in which terminal groups are not stabilized, a product of Mitsui Du Pont Fluorochemical Co.

Further, VGCF is vapor phase method carbon fibers having a diameter of 150 nm, a product of Showa Denko K.K., and CNT 20 is carbon nanotubes having a diameter of 20 nm, a product of Carbon Nanotech Research Instituted.

TABLE 1

| | | | | | | | | | Conductivity | Static |
|---|---|---|---|---|---|---|---|---|---|---|
| | PFA450HPJ | PFA440HPJ | FEP100J | PFA350J | PFA34OJ | FEP120J | VGCF | CNT20 | (Ω/□) | characteristics |
| Sample 1 | 96 | | | | | | 4 | | >10¹³ | Good |
| Sample 2 | 95 | | | | | | 5 | | 10¹¹ | Good |
| Sample 3 | 94 | | | | | | 6 | | 10⁵ | Good |
| Sample 4 | 93 | | | | | | 7 | | 10³ | Good |
| Sample 5 | 63 | | | 31 | | | 6 | | 10¹¹ | Good |
| Sample 6 | 47 | | | 47 | | | 6 | | 10¹² | Good |
| Sample 7 | 31 | | | 63 | | | 6 | | 10¹³ | Good |
| Sample 8 | | 98 | | | | | 2 | | >10¹³ | Good |
| Sample 9 | | 97 | | | | | 3 | | 10¹³ | Good |
| Sample 10 | | 96 | | | | | 4 | | 10⁵ | Good |
| Sample 11 | | | 93 | | | | 7 | | 10⁵ | Good |
| Sample 12 | 95 | | | | | | | 5 | 10⁵ | Good |
| Sample 13 | 90 | | | | | | | 10 | 10⁰ | Good |
| Sample 14 | | 95 | | | | | | 5 | 10⁴ | Good |
| Sample 15 | | 93 | | | | | | 7 | 10⁰ | Good |
| Comparison 1 | | | | 94 | | | 6 | | >10¹³ | Poor |
| Comparison 2 | | | | | 96 | | 4 | | >10¹³ | Poor |
| Comparison 3 | | | | | | 93 | 7 | | >10¹³ | Poor |
| Comparison 4 | | | | 95 | | | | 5 | >10¹³ | Poor |
| Comparison 5 | | | | 94 | | | | 6 | >10¹³ | Poor |
| Comparison 6 | | | | | 95 | | | 5 | >10¹³ | Poor |

Another embodiment according to the invention is described below.

In the fluororesin composition using the carbon nanotubes as a conductive filler according to another embodiment of the invention, it has been found that because the carbon nanotubes are previously treated with a fluorine-based surfactant, affinity with the fluororesin used increases, and as a result, a fluororesin composition having large conductivity with a blending amount of the carbon nanotubes in smaller amount, and having no falling off of the filler, and having good process ability and mechanical properties is provided.

Further, it has been found that properties of the fluororesin composition obtained greatly change depending on the chemical structure of the terminal groups of the fluororesin used, and conductivity and static properties change depending on the structure of the terminal groups, and it has been found that a fluororesin composition excellent in conductivity and the like can be provided by using a fluororesin having specific terminal groups.

In the fluororesin composition in another embodiment of the invention, where the carbon nanotubes treated with a fluorine-based surfactant are used, and are mixed with a fluororesin in which terminal groups are stabilized, it exhibits excellent properties in electric conductivity, particularly static charging characteristics.

As the fluorine-based surfactant used in the fluororesin composition in another embodiment of the invention, there can be mentioned fluoroalkylsulfonic acid or its salt, and fluoroalkylcarboxylic acid or its salt. Specifically, there can be mentioned potassium perfluorooctanesulfonate, lithium perfluorooctanesulfonate and potassium perfluorobutanesulfonate.

The treatment method by the fluorine-based surfactant in another embodiment of the invention can be conducted by a method of contacting the fluorine-based surfactant with the carbon nanotubes, and for example, can be conducted by dipping the carbon nanotubes in an organic solvent solution or an aqueous solution of the fluorine-based surfactant, and then conducting dry treatment.

The amount of the fluorine-based surfactant added is preferably 0.001 mass % or more, and more preferably 0.003 mass % or more and 5 mass % or less, to the whole composition. The amount of 0.005 mass % or more and 2 mass % or less is more preferable. The addition amount is an amount that does not include a solvent.

Where the addition amount is less than 0.001 mass %, good conductivity is not obtained, and where it is more than 5 mass %, process ability deteriorates.

As the fluororesin that can be used in the production of the fluororesin composition in another embodiment of the invention, there can be mentioned a polytetrafluoroethylene (PTFE), a tetrafluoroethylene-fluoroalkylvinyl ether copolymer (PFA), a tetrafluoroethylene-hexafluoropropylene copolymer (FEP), a tetrafluoroethylene-ethylene copolymer (ETFE), a polyvinylidene fluoride (PVDF), a polychlorotrifluoroethylene (PCTFE), a ethylenechloro-trifluoroethylene copolymer (ECTFE), and the like.

The fluororesin in which terminal groups are stabilized is one that the fluororesin obtained by polymerization is subjected to fluorination treatment of terminal groups with a fluorinating agent, and specifically, there can be mentioned at least one kind selected from a tetrafluoroethylene-hexafluoropropylene copolymer (FEP), a tetrafluoroethylene-fluoroalkylvinyl ether copolymer (PFA), a tetrafluoroethylene-ethylene copolymer (ETFE), and a tetrafluoroethylene-hexafluoropropylene-vinylidene fluoride terpolymer (THV).

Of those, overall fluorinated polymers are preferable, and a tetrafluoroethylene-hexafluoropropylene copolymer (FEP) and a tetrafluoroethylene-fluoroalkylvinyl ether copolymer (PFA) are more preferable.

In another embodiment of the invention, the fluororesin in which terminal groups are not stabilized may be blended together with fluororesin in which terminal groups are stabilized. To make the properties by the fluororesin in which terminal groups are stabilized sufficient, it is preferable that ⅓ or more of the total mass of the fluororesin used is the fluororesin in which terminal groups are stabilized, and it is more preferable that ½ or more of the total mass of the fluororesin used is the fluororesin in which terminal groups are stabilized.

The carbon nanotubes that can be used in the fluororesin composition in another embodiment of the invention can mention carbon nanoporous bodies having conductivity, such as single wall carbon nanotubes (SWCNT), multiwalled carbon nanotubes (MWCNT), vapor phase growth carbon fibers (VGCF) and carbon nanohorns.

Further, it is preferable that the carbon nanotubes have a diameter of from 1 nm to 300 nm, and an aspect ratio of 5 or more.

In another embodiment of the invention, the carbon nanotubes are preferably 0.1 mass % or more, and more preferably 1 mass % or more, on the basis of the mass of the whole composition. However, the blending ratio can adjust the blending amount according to conductive characteristics of the desired fluororesin composition.

Further, the carbon nanotubes may be used as a masterbatch in which a resin has previously been mixed and kneaded, from the point of improving dispersibility to the fluororesin. It is preferable that the resin used for the formation of the masterbatch uses the same fluororesin as in the fluororesin composition finally produced.

After mixing the fluororesin and the carbon nanotubes in a predetermined proportion, the fluororesin composition in another embodiment of the invention can be molded into the desired shape by an extrusion molding method, a roll molding method, an injection molding method or the like.

The invention is further described below by referring to the following Examples and Comparative Examples.

### EXAMPLE

Carbon nanotubes were added to the fluorine-based surfactant shown in Table 2 in an amount so as to be a blending portion of a solid content shown in Table 2, followed by well stirring and drying at 110° C.

Each of fluororesin pellets and carbon nanotubes was supplied from two feeders to a hopper of a twin-screw extruder (KZW20-25G, a product of Technovel Corp.) so as to be the weight proportion of Table 2. The twin-screw extruder was set such that a cylinder temperature is 330° C. and a die temperature is 340° C., and the fluororesin and the carbon nanotubes were melt-kneaded and extruded into a strand form at the number of revolutions of a screw of 30 rpm. After-cooling in a water bath, pellets having a diameter of 1.5 mm and a length of 3 mm were produced with a pelletizer.

Further, in comparison 10, FEP120J which is a dispersion was dried, a surfactant was washed out with methanol, a strand was extruded with a single-screw extruder, and pellets having a diameter of 1.5 mm and a length of 3 mm were formed with a pelletizer, and were used.

In Table 2, comparison means a comparative example.

Measurement of Conductivity

Conductivity was determined by kneading with a twin-screw extruder and molding 10 g of the pellets obtained into a sheet form having a thickness of 0.2 mm with a hot press at 350° C., and measuring a surface resistance using a high resistivity meter (HIRESTA-IP, a product of Mitsubishi Chemical Corp.) and a low resistivity meter (LORESTA-AP, a product of Mitsubishi Chemical Corp.). The evaluation results are shown in Table 2 with Ω/□ as a unit.

Measurement of Static Charging Properties

100 g of sample pellets was charge eliminated using a static eraser (SF-1000, a product of As One Corporation), and placed in a polyethylene bag. A mouth of the bag is closed while inflating the bag, and the bag was vigorously shaken up and down 10 times. It was evaluated as to whether or not the pellets in the bag adhered to a wall of the bag by static electricity. Where the pellets did not adhered, it was evaluated as “good”, and where the pellets adhered, it was evaluated as “poor”.

In Table 2, PFA350J, PFA450J, PFA340J and PFA420J each show tetrafluoroethylene-fluoroalkylvinyl ether copolymers (PFA), products of Mitsui Du Pont Fluorochemical Co. Further, PFA450J and PFA420J are ones that terminal groups are stabilized.

FEP100J and FEP120J each show tetrafluoroethylene-hexafluoropropylene copolymers (FEP), products of Mitsui Du Pont Fluorochemical Co. Further, FEP100J is one that terminal groups are stabilized.

Further, ETFEC88AX shows a tetrafluoroethylene-ethylene copolymer (ETFE), a product of Asahi Glass Co.

Further, the numerical values show a blending weight ratio of a solid content.

The surfactants are as follows.

SA1: Showing potassium perfluorooctanesulfonate, and one by treating carbon nanotubes in a 4 mass % methanol solution.

SA2: Showing lithium perfluorooctanesulfonate, and one by treating carbon nanotubes in a 4 mass % methanol solution.

SA3: Showing lithium perfluorobutanesulfonate, and one by treating carbon nanotubes in a 4 mass % aqueous solution.

Further, the numerical values show a blending weight ratio of a solid content of the surfactant.

CNT shows carbon nanotubes.

VGCF is vapor phase method carbon fibers having a diameter of 150 nm, a product of Showa Denko K.K.

CNT20 is carbon nanotubes having a diameter of 20 nm, a product of Carbon-Nanotech-Research-Institute.

Further, the numerical values show a blending weight ratio of a solid content.

TABLE 2

| | Fluororesin | | | | | | | | | | | | | |
|---|---|---|---|---|---|---|---|---|---|---|---|---|---|---|
| | PFA | PFA | PFA | PFA | FEP | FEP | ETFE | Surfactant | | | CNT | | Conductivity | Static |
| | 350J | 450J | 340J | 420J | 100J | 120J | C88AX | SA1 | SA2 | SA3 | VGCF | CNT20 | (Ω/□) | Characteristics |
| Sample 16 | | 94.0 | | | | | | 0.005 | | | 6 | | >10¹³ | Good |
| Sample 17 | | 94.0 | | | | | | 0.05 | | | 6 | | >10¹³ | Good |
| Sample 18 | 93.5 | | | | | | | 0.5 | | | 6 | | 10¹⁰ | Good |
| Sample 19 | | 93.5 | | | | | | 0.5 | | | 6 | | 10⁴ | Good |
| Sample 20 | 92.8 | | | | | | | 1.2 | | | 6 | | 10⁷ | Good |
| Sample 21 | | 92.8 | | | | | | 1.2 | | | 6 | | 10³ | Good |
| Sample 22 | | | 97.8 | | | | | 0.2 | | | | 2 | >10¹³ | Good |
| Sample 23 | | | | 97.8 | | | | 0.2 | | | | 2 | 10¹⁰ | Good |
| Sample 24 | | | | 95.8 | | | | 0.2 | | | | 4 | 10⁴ | Good |
| Sample 25 | | | 95.8 | | | | | | 0.2 | | | 4 | 10¹⁰ | Good |
| Sample 26 | | | | 95.8 | | | | | 0.2 | | | 4 | 10⁴ | Good |
| Sample 27 | | | | 91.8 | | | | | 0.2 | | | 6 | 10⁰ | Good |
| Sample 28 | | | | 95.8 | | | | | | 0.2 | | 4 | 10⁴ | Good |
| Sample 29 | | | | | 93.8 | | | 0.2 | | | 6 | | 10⁴ | Good |
| Sample 30 | | | | | 95.8 | | | | | 0.2 | | 4 | 10⁴ | Good |
| Sample 31 | | | | | | 95.8 | | | | 0.2 | | 4 | 10⁸ | Good |
| Sample 32 | | | | | | | 93.7 | | | 0.3 | 6 | | 10⁵ | Good |
| Comparison 7 | 94 | | | | | | | | | | 6 | | >10¹³ | Poor |
| Comparison 8 | | | 96 | | | | | | | | | 4 | >10¹³ | Poor |
| Comparison 9 | | | | | | 94 | | | | | 6 | | >10¹³ | Poor |
| Comparison 10 | | | | | | 96 | | | | | | 4 | >10¹³ | Poor |
| Comparison 11 | | | | | | | 94 | | | | 6 | | >10¹³ | Poor |

### INDUSTRIAL APPLICABILITY

The fluororesin composition of the invention uses carbon nanotubes as a conductive filler, and also uses a fluororesin in which terminal groups are stabilized, as a fluororesin. Therefore, the composition can provide a fluororesin composition excellent in conductive characteristics, particularly static charging properties, and can be utilized in the production of electric materials and electronic materials, excellent in electrical characteristics such as conductivity and static properties. Further, the fluororesin composition of the invention uses carbon nanotubes having been subjected to treatment with a fluorine-based surfactant. Therefore, the composition can provide a fluororesin composition excellent in conductive characteristics, particularly static charging properties, and can be utilized in the production of electric materials and electronic materials, excellent in electrical characteristics such as conductivity and static properties.

1. A fluororesin composition, characterized by comprising a fluororesin in which terminal groups are stabilized, and carbon nanotubes.

2. The fluororesin composition as claimed in claim 1, characterized in that the fluororesin in which terminal groups are stabilized is selected from a perfluoroalkoxyalkane polymer, or a perfluoroethylene propylene copolymer.

3. A fluororesin composition, characterized in that a fluororesin and carbon nanotubes surface treated with a fluorine-based surfactant are blended.

4. The fluororesin composition as claimed in claim 3, characterized in that the fluorine-based surfactant is at least one kind selected from the group consisting of fluoroalkylsulfonic acid, fluoroalkylcarboxylic acid, and their salts.

5. The fluororesin composition as claimed in any one of claim 3 or 4, characterized in that the fluororesin is one that terminal groups are stabilized.

6. The fluororesin composition as claimed in any one of claims 3 to 5, characterized in that the fluororesin in which terminal groups are stabilized is selected from a perfluoroalkoxyalkane polymer, or a perfluoroethylene propylene copolymer.
